(19) United States
(12) Patent Application Publication
(10) Pub. No.: US 2003/0040504 A1
(43) Pub. Date: Feb. 27, 2003

(54) Ectoparasiticidal compositions and methods of their use

(76) Inventors: Eugene H. Gans, Westport, CT (US); Nicholas F. Schmidt, Bolton Landing, NY (US); John M. Clark, Amherst, MA (US)

Correspondence Address: Reed Smith LLP, 2500 One Liberty Place, 1650 Market Street, Philadelphia, PA, 19103-7301, US

(21) Appl. No.: 10/142,245

(22) Filed: May 9, 2002

Related U.S. Application Data
(60) Provisional application No. 60/290,332, filed on May 9, 2001.
(60) Provisional application No. 60/290,333, filed on May 9, 2001.
(60) Provisional application No. 60/290,567, filed on May 9, 2001.

(51) Int. Cl. A01N 65/00

(52) U.S. Cl. 514/72; 514/74

(57) ABSTRACT

The present invention provides compositions and methods for killing mammalian ectoparasites and eggs. The present invention provides compositions comprising active ingredients, such as, for example, terpenes, such as dipentene and/or D limonene; and/or terpene-ols, such as, for example, terpineol and 1-terpinen-4-ol; and/or 1,2,3,4,-tetrahydronaphthalene; and/or aromatic alcohols; and/or essential oils. The present invention also provides, compositions and methods for killing mammalian ectoparasites and eggs which are resistant to ingredient(s) in established insecticides, such as for example, malathion, permethrin and/or lindane.

### RELATED APPLICATIONS

This patent application claims priority of provisional applications U.S. Serial Nos. 60/290,332, 60/290,333, and 60/290,567 all of which were filed on May 9, 2001.

### FIELD OF THE INVENTION

The present invention relates to insecticidal compositions for the treatment of mammalian ectoparasites and methods of making the compositions; and composition and methods for killing mammalian ectoparasites and their eggs, in particular, those which are resistant to ingredients in established insecticidal compositions. The present invention also relates to the treatment of mammalian ectoparasites comprising administration of the insecticidal compositions disclosed herein.

### BACKGROUND OF THE INVENTION

In an attempt to repel insects, people have turned to widely marketed lotions and sprays which contain active ingredients that have a number of harmful side-effects. In particular, the occurrence of lice, such as head lice (Pediculus capitis), body lice (Pediculus corporis) and pubic lice (Phthiris pubis), is an ongoing problem and many commercial products for their treatment are associated with harmful side effects.

Initially, lice infestations result in irritation which can lead to infections. Additionally, there are at least three diseases primarily transmitted by lice: epidemic typhus, trench fever and relapsing fever. See U.S. Pat. No. 5,411,992, issued May 2, 1995. After World War II, the epidemic of typhus transmitted by body lice was controlled with DDT. Downs discloses insecticides used in topical formulations for the treatment of the human head lice in the U.K. including, DDT, natural pyrethrum, lindane, malathion, carbaryl, phenothrin and permethrin. Downs, et al., Parasitology Today, vol. 15: pages 1-4 (1999). Downs reports that DDT and lindane were withdrawn in the U.K. due to toxicity issues as well as treatment failure and that carbaryl is only available from the National Health Service in the U.K. due to suspected mutagenic potential with chronic use. See Supra pages 1-4.

U.S. Pat. Nos. 5,411,992 and 5,227,163 disclose lice repellents that comprise terpenoids. Licicidal and lice-ovicidal formulations comprising D-limonene are disclosed in Canadian Patent Application 2,060,594 and pesticide compositions comprising D-limonene are disclosed in U.S. Pat. No. 4,379,168; PCT publication WO 98/48625; and PCT publication WO 00/36912. Gustafson discloses that D-limonene exhibits insecticidal and bactericidal activity. Spray Technology & Marketing, page 24 (January 2001). Formulations of one or more terpenes in aqueous solutions are disclosed in U.S. Pat. No. 5,977,186. Monoterpenoids and 1,2,3,4,-tetrahydronaphthalene as pediculocides are disclosed by Downs et al. in British Journal of Dermatology, 141 (Suppl. 55) pages 102-107 (1999) and Acta-Derm Venerol., vol. 80: 69 (1999).

U.S. Pat. No. 5,621,013 and WO 97/07677 disclose compositions comprising crystalline 3,8 P-menthanediol (Chinese crystal). Insecticide compositions comprising rotenone as active agent, are disclosed in U.S. Pat. No. 5,609,878. Pediculicidal compositions that comprise piperonal are disclosed in U.S. Pat. No. 5,696,158. Shampoos comprising pyriproxyfen are disclosed in U.S. Pat. No. 5,866,152 and insecticides comprising pyriproxyfen for the treatment of animals are disclosed in U.S. Pat. No. 5,942,525. Essential oils used as treatment for head lice are discussed by Veal, L. (1996, Complementary Therapies in Nursing & Midwifery, vol. 2: pages 97-101 (1996) and lice repelling preparations comprising natural oils are disclosed in U.S. Pat. No. 5,518,736 and PCT publication WO 00/000213.

The use of ivermectin for the treatment of rosacea in humans is disclosed in U.S. Pat. No. 5,952,372. The use of ivermectin for the treatment of endoparasites is disclosed in U.S. Pat. No. 6,159,932. Thiabendazole for the treatment of fungus is disclosed in U.S. Pat. No. 4,962,093.

Other compositions and methods for lice insecticide treatments include those disclosed in U.S. Pat. No. 5,783,202; PCT publication WO 99/29174; PCT publication WO 99/18800; and UK patent applications GB 2,343,627 and GB 2,204,243. Established pesticides containing pyrethrin, pyrethrum, permethrin, pyrethroids, lindane or malathion are disclosed in The Pesticide Book, third edition, (G. Ware, Thomson publications, Fresno, 1989) and include RIDS® products from Pfizer; NIX® from Warner Lambert; ELIMITE® from Allergan; CLEAR® from Care Technologies Inc.; PRONTO® from Del; Lyclear™ from Warner Lambert; KWELL® from Reedco, Inc.; OVIDE® (malathion 0.5%) lotion from Medicis Pharmaceutical Corp.; Derbac-M from Seton Laboratories, U.K.; and Suleo-M from Seton Laboratories, U.K. CUPREX® from E. Merck Co. is a combination of 1,2,3,4,-tetrahydronaphthalene and copper oleate, wherein copper oleate is 9-octadecenoic acid copper salt. HairClean 1-2-3 Lice Remover from Quantum Health comprises coconut oil, anise oil, ylang ylang oil and isopropyl alcohol.

Downs, et al., (Parasitology Today, vol. 15: pages 1-4) (1999), further discloses that insecticide resistance to pyrethroids has been reported from England, France, Israel and the Czech Republic and insecticide resistance to organophosphates has been reported from England and France. Downs, et al., (British Journal of Dermatology, vol.141: pages 508-511 (1999) reports finding a high resistance to both permethrin and malathion in head lice collected from school children in the United Kingdom.

Evidence of lindane tolerance in lice in the Western Hemisphere has been reported by Meinking, T. L. et al., Adv. Dermatol, Vol. 5: Pages 131-152 (1990) and Meinking, T. L., Curr Probl Dermatol, Vol. 11: pages 73-120 (1999).

In spite of the presence of established compositions for the treatment of mammalian ectoparasites, there remains a need for effective compositions for the treatment of such ectoparasites.

### BRIEF SUMMARY OF THE INVENTION

The present invention relates to compositions and methods for killing mammalian ectoparasites and mammalian ectoparasite eggs, and optionally killing only the eggs or only the ectoparasite. In this specification, killing ectoparasites includes killing ectoparasites, preventing their eggs from hatching or a combination thereof.

The present invention provides compositions for killing mammalian ectoparasites, comprising an aromatic alcohol, as an active ingredient, and a carrier for topical application to a mammal. The composition optionally further comprises one or more additional active ingredients, including but not limited to pyrethrin, dipentene and ∝-terpineol. Optionally, the composition comprises a synergist of an active ingredient, a detergent (preferably laureth-4), and/or a gel agent (preferably hydroxyethyl cellulose, or hydroxypropyl cellulose). The composition is preferably a topically applied composition, including, but not limited to, a cleanser (preferably a shampoo) or a gel. The present invention also comprises the methods of using such compositions for killing ectoparasites.

An embodiment of the present invention comprises pyrethrum, benzyl alcohol, α-terpineol, D-limonene and a carrier for topical application. The pyrethrum, benzyl alcohol (preferably at about 4.5% w/w), α-terpineol (preferably at about 2.5% w/w) and D-limonene (preferably at about 2.5% w/w) are each present in an amount effective to kill ectoparasites. (Percentages given in this specification are weight percentages unless otherwise noted.) The composition does not contain an effective amount of malathion, 3,8-P-methanediol, rotenone and piperonal. Optionally, the embodiment may comprise a synergist of one of the active ingredients, preferably a synergist of pyrethrum, piperonyl butoxide. The carrier comprises an alcohol, aqueous solution or combination thereof, including but not limited to isopropanol, or ethyl alcohol. The composition is preferably a topically applied composition, including, but not limited to, a cleanser (preferably a shampoo) or a gel. The present invention also comprises the methods of using such compositions for killing ectoparasites, and preferably their eggs too.

Another embodiment of the present invention comprises compositions for removing mammalian ectoparasites, including ectoparasites, their eggs and combinations thereof, comprising an aromatic alcohol, as an active ingredient, and a carrier for topical application to a mammal, and is substantially free from other active ingredients. The composition optionally further comprises one or more additional active ingredients, including but not limited to pyrethrin, dipentene and ∝-terpineol. Optionally, the composition comprises a synergist of an active ingredient, a detergent (preferably laureth-4), and/or a gel agent (preferably hydroxyethyl cellulose, or hydroxypropyl cellulose). The composition is preferably a topically applied composition, including, but not limited to, a cleanser (preferably a shampoo) or a gel. The present invention also comprises the methods of using such compositions for removing ectoparasites.

Another embodiment of the present invention comprises a method of removing mammalian ectoparasites, their eggs or combinations thereof. The method comprises applying topically to a mammal one of the compositions described in this specification, and rinsing the composition from the mammal with water. The cleansing substantially removes the live and dead ectoparasites, their eggs or combination thereof. Removing ectoparasites means the removal of ectoparasites, their eggs or a combination thereof.

The present invention provides compositions for killing mammalian ectoparasites, and preferably their eggs too, comprising:

i) a first active ingredient selected from the group consisting of terpenes and terpene-ols;

ii) a second active ingredient that is not identical to said first active ingredient, wherein

a) said second active ingredient is selected from the group consisting of terpene-ols; essential oils; 1,2,3,4,-tetrahydronapthalene; and benzyl alcohol, when said first active ingredient is a terpene, and

b) said second active ingredient is selected from the group consisting of terpenes, terpene-ols; essential oils; 1,2,3,4,-tetrahydronapthalene; and benzyl alcohol, when said first active ingredient is a terpene-ol; and

iii) a carrier for topical application to a mammal, wherein each of said first and said second active ingredients is present in an amount effective to kill said ectoparasites and wherein said composition does not contain an effective amount of malathion; 3,8 P-menthanediol (Chinese crystal); rotenone; or piperonal. In some embodiments, the first and said second active ingredients are selected from different categories of active ingredients. In other embodiments, a composition further comprises a third active ingredient present in an amount effective to kill ectoparasites. In yet further embodiments, each of said first and said second ingredients kills within about the same general period of time. In some embodiments of the present invention, ectoparasites include head lice, body lice, pubic lice, head mites, scabies, body mites, pubic mites, and fleas. Some embodiments of the present invention are effective at killing ectoparasites, which are resistant to established insecticidal compositions, such as, for example, malathion, permethrin and lindane or combinations thereof.

The present invention provides compositions for killing mammalian ectoparasites that comprise

i) dipentene present in an amount effective to kill said ectoparasites;

ii) terpineol present in an amount effective to kill said ectoparasites; and

iii) a carrier for topical application to a mammal, wherein said composition does not contain an effective amount of malathion; 3,8 P-menthanediol (Chinese crystal); rotenone; or piperonal. In some embodiments, compositions further comprise at least one additional active ingredient. In yet further embodiments, additional active ingredients include terpinene-4-ol; 1,2,3,4-tetrahydronaphthalene; thiabendazole; ivermectin; pyriproxyfen; or benzyl alcohol. In additional embodiments, compositions further comprise an essential oil selected from the group consisting of tea tree oil, peppermint oil, sesame oil, pine needle oil, bergamot oil, sage oil, styrax oil, red thyme oil, oregano oil, aniseed oil, and cinnamon leaf oil.

The present invention provides methods for killing mammalian ectoparasites on a mammal infected with ectoparasites comprising applying to a mammal in need of such treatment a composition comprising malathion in a range of from about 0.10% w/w to about 2% w/w; dipentene and/or D-limonene in a range of from about 0.1% w/w to about 40% w/w; and terpineol in a range of from about 0.1% w/w to about 40% w/w. In other embodiments of the methods, compositions comprise malathion in a range of from about 0.20% w/w to about 5% w/w (preferably from about 0.1 to about 2%, more preferably about 0.20% w/w to about 0.75% w/w); dipentene in a range of from about 5% to about 12% w/w; and terpineol in a range of from about 5% to about 12% w/w. In further embodiments of the method, compositions comprise malathion in a range of from about 0.50% w/w to about 0.60% w/w; dipentene in a range of from about 8% to about 10% w/w; and terpineol in a range of from about 8% to about 10% w/w.

In an additional embodiment of the method, the mammal is selected from the group consisting of a human, dog and cat. In other embodiments, the ectoparasite is selected from the group consisting of mites, fleas, scabies, head lice, pubic lice, body lice and a combination thereof. In a preferred embodiment, the mammalian ectoparasites are human lice. In further embodiments, the ectoparasites are resistant to malathion, permethrin, or lindane, or a combination thereof.

The present invention also provides methods for killing mammalian ectoparasites on a mammal infected with ectoparasites, which are resistant to at least one active ingredient, comprising applying to a mamnial in need of such treatment a composition comprising i) malathion, ii) dipentene, iii) terpineol, iv) an essential oil and v) isopropanol. In other embodiments, compositions used in the methods comprise malathion from about 0.02% to about 5%, preferably from 0.10% w/w to about 2% w/w, more preferably from about 0.25% to about 0.75%; dipentene and/or D-limonene from about 1% w/w to about 40% w/w; and terpineol from about 1% w/w to about 40% w/w. In additional embodiments, the compositions used in the methods comprise malathion from about 0.20% w/w to about 0.75% w/w; dipentene from about 5% w/w to about 12% w/w; and terpineol from about 5% w/w to about 12% w/w. In yet further embodiments, the compositions used in the methods comprise malathion from about 0.50% to about 0.60% w/w; dipentene from about 8% w/w to about 10% w/w; and terpineol from about 8% w/w to about 10% w/w. In yet additional embodiments, compositions further comprise at least one additional active ingredient selected from the group consisting of terpinene-4-ol, 1,2,3,4-tetrahydronaphthalene, thiabendazole, ivermectin, pyriproxyfen and benzyl alcohol.

In yet further embodiments of the present invention, compositions comprise terpene-ol, such as, for example, terpineol or terpinen-4-ol; and/or a terpene, such as, for example, dipentene or D-limonene; and may further comprise, other active ingredients, such as, for example, 1,2,3,4,-tetrahydronaphthalene, thiabendazole, ivermectin, pyriproxyfen, benzyl alcohol, an essential oil or mixtures thereof.

In some embodiments, a composition of the present invention comprise a carrier comprising tea tree oil, peppermint oil, sesame oil, pine needle oil, bergamot oil, sage oil, styrax oil, red thyme oil, oregano oil, aniseed oil, cinnamon leaf oil and mixtures thereof. In yet further embodiments, a composition comprises a carrier including an alcohol solution or dispersed system, an aqueous solution or dispersed system, or an alcohol/aqueous solution or dispersed system. In other embodiments, the carrier is isopropanol.

In other embodiments, the present invention provides compositions for killing mammalian ectoparasites that comprises,

i) dipentene present in an amount effective to kill said ectoparasites;

ii) terpineol present in an amount effective to kill said ectoparasites;

iii) a third active ingredient present in an amount effective to kill said ectoparasites; and

iv) a carrier for topical application to a mammal, wherein said composition does not contain an effective amount of malathion, 3,8 P-menthanediol (Chinese crystal), rotenone, or piperonal. In yet other embodiments, the third active ingredient is selected from the group consisting of 1,2,3,4,tetrahydronaphthalene, thiabendazole, ivermectin, pyriproxyfen, benzyl alcohol and an essential oil.

In further embodiments, the present invention provides compositions for killing mammalian ectoparasites consisting essentially of a mixture of dipentene and terpineol effective to kill said ectoparasites and a carrier for topical application to a mammal; compositions for killing mammalian ectoparasites consisting essentially of a mixture of dipentene, terpineol and 1,2,3,4,-tetrahydronaphthalene effective to kill said ectoparasites and a carrier for topical application to a mammal; compositions for killing mammalian ectoparasites consisting essentially of a mixture of dipentene, terpineol and an essential oil effective to kill said ectoparasites and a carrier for topical application to a mammal; compositions for killing mammalian ectoparasites consisting essentially of a mixture of dipentene, terpineol, 1,2,3,4-tetrahydronaphthalene and an essential oil effective to kill ectoparasites and a carrier for topical application to a mammal; and compositions for killing mammalian ectoparasites consisting essentially of a mixture of dipentene, terpineol and aromatic alcohol, preferably benzyl alcohol, effective to kill said ectoparasites and a carrier for topical application to a mammal.

In yet additional embodiments, the present invention provides compositions for killing mammalian ectoparasites consisting essentially of a mixture of dipentene; terpineol; aromatic alcohol, preferably benzyl alcohol; and terpinen-4-ol effective to kill said ectoparasites and a carrier for topical application to a mammal.

In some embodiments, a composition comprises dipentene from about 0.10% w/w to about 50% w/w and terpineol from about 0.10% w/w to about 50% w/w; dipentene from about 2.50% w/w to about 20% w/w and terpineol from about 2.50% w/w to about 20% w/w; or dipentene from about 5% w/w to about 15% w/w and terpineol from about 5% w/w to about 15% w/w.

The present invention also provides methods for killing mammalian ectoparasites on a mammal. Accordingly, the present invention provides methods for killing mammalian ectoparasites on a mammal infected with ectoparasites, which are resistant to at least one active ingredient, comprising, applying to a mammal in need of such treatment a composition for killing mammalian ectoparasites comprising:

i) a first active ingredient selected from the group consisting of terpenes and terpene-ols;

ii) a second active ingredient that is not identical to said first active ingredient, wherein

a) said second active ingredient is selected from the group consisting of terpene-ols; essential oils; 1,2,3,4,-tetrahydronapthalene; and aromatic alcohol, preferably benzyl alcohol, when said first active ingredient is a terpene, and

b) said second active ingredient is selected from the group consisting of terpenes, terpene-ols; essential oils; 1,2,3,4,-tetrahydronapthalene; and aromatic alcohol, preferably benzyl alcohol, when said first active ingredient is a terpene-ol; and

iii) a carrier for topical application to a mammal, wherein each of said first and said second active ingredients is present in an amount effective to kill said ectoparasites and wherein said composition does not contain an effective amount of malathion, 3,8 P-menthanediol (Chinese crystal), otenone, or piperonal, and wherein each active ingredient kills within about the same general period of time. In some embodiments, neither of said first nor said second active ingredient is identical to said active ingredient to which said ectoparasite is resistant. In some embodiments, the ectoparasites are resistant to malathion, permethrin and/or lindane. In some embodiments of the method, said first active ingredient is a terpene, such as, dipentene; a terpene-ol, such as terpineol or terpinen-4-ol; aromatic alcohol, preferably benzyl alcohol; or an essential oil. In other embodiments of the method, compositions further comprise an acceptable carrier, such as, an alcohol solution or dispersed system, an aqueous solution or dispersed system, or an alcohol/aqueous solution or dispersed system.

The present invention also provides methods for killing mammalian ectoparasites on a mammal infected with ectoparasites, which are resistant to at least one active ingredient, comprising applying to a mammal in need of such treatment a composition comprising

i) dipentene;

ii) terpineol;

iii) an essential oil; and

iv) isopropanol wherein said composition does not contain an effective amount of malathion, rotenone, or piperonal. In some embodiments, the composition comprises dipentene from about 0.10% w/w to about 50% w/w and terpineol from about 0.10% w/w to about 50% w/w; dipentene and/or D-limonene from about 2.50% w/w to about 20% w/w and terpineol from about 2.50% w/w to about 20% w/w; or dipentene from about 5% w/w to about 15% w/w and terpineol from about 5% w/w to about 15% w/w. In other embodiments of the methods, a composition further comprises an active ingredient selected from the group consisting of terpinen-4-ol, 1,2,3,4-tetrahydronaphthalene, thiabendazole, ivermectin, pyriproxyfen and aromatic alcohol, preferably benzyl alcohol.

### DETAILED DESCRIPTION OF THE INVENTION

The present invention provides compositions and methods for killing mammalian ectoparasites, such as, for example, head lice (Pediculus capitis), body lice (Pediculus corporis), pubic lice (Phthiris pubis), scabies, Demodex mites, such as, Demodex folliculorum and Demodex brevis and fleas, such as, the human flea, Pulex irritans, the cat flea, Ctenocephalides felis, and the dog flea, Ctenocephalides canis. In preferred embodiments, the compositions and methods disclosed herein are used on humans to control human ectoparasites and in particular, human lice. The compositions and methods disclosed herein provide benefits such as, for example, more effective prevention of the development of resistance by the ectoparasites to active ingredients and/or ability to kill ectoparasites resistant to active ingredient(s), such as, for example, malathion, permethrin, and/or lindane, found in commercially available compositions, such as, over the counter and prescription compositions.

Active Ingredients

Active ingredients are effective at killing ectoparasites, their eggs or combinations thereof.

Organophosphate insecticides include malathion which is also known as [(dimethoxyphosphinothioyl)thio]butanedioic acid diethyl ester. Downs, et al., British Journal of Dermatology, vol. 141: pages 508-511) (1999) state that malathion irreversibly binds to acetylcholinesterase preventing its function and causing spastic paralysis and death in insects. Downs suggests that a specific malathion resistance mechanism is in operation in head lice which are resistant to malathion.

Terpenes are well known naturally occurring unsaturated hydrocarbons found in many essential oils and oleophilic plant resins. As used herein, “terpene” includes the saturated derivatives of the unsaturated hydrocarbons as well as mixtures of saturated and unsaturated terpenes. The carbon backbone of terpenes are formed exclusively of head to tail dimerization products of isopentyl (isoprene) units. Many of these compounds are commercially available. Methods for synthesis of terpenes are also known to those skilled in the art. Examples of references containing methods of synthesis of terpenes include Chemistry of Terpenes and Terpenoids. A. A. Newman, ed., Academic Press (1972),and references cited therein, the teachings of which are incorporated therein. In some embodiments disclosed herein, a preferred terpene is dipentene in the form of a racemic mixture of DL-limonene, that is a mixture that contains both D-limonene and L-limonene or preferably, D-limonene alone. Limonene (1-Methyl-4-(1-methylethenyl) cyclohexene) occurs in various ethereal oils particularly in oils of lemon, orange, caraway, dill and bergamot. See the Merck Index, twelfth edition, Budavari et al., published by Merck Research Laboratories Division of Merck & Co., Inc. New Jersey, page 938 for a description of dipentene.

Rotenone means rotenone including but not limited to, reduced rotenone.

Terpene-ols are terpenes which have at least one hydroxyl group. Examples of terpene-ols include: C₁₀H₁₆O compounds, perillyl alcohol, carveol, myrtenol, and cis-verbenol; C₁₀H₁₈O compounds, myrtanol, iso-pinocampheol, dihydrocarveol, isopulegol, terpineol (also referred to interchangeable herein as α-terpineol), terpinen-4-ol, nerol, geraniol, and linalool, and C₁₀H₂₀O compounds, menthol, β-citronellol, and dihydro-myrcenol and mixtures thereof. In preferred embodiments disclosed herein, the terpene-ols include terpineol and terpinen-4-ol and mixtures thereof. For information regarding terpineol and terpinen-4-ol, see the Merck Index supra, page 1568 and page 1567, respectively.

Terpene-esters are terpenes which have at least one ester group which is the product of the bonding of the hydroxyl group of a terpene-ol with an aliphatic carboxylic acid that can contain functional groups such as the hydroxyl or amine on the aliphatic chain. Examples of suitable aliphatic carboxylic acids include acetic acid, propionic acid, lactic acid, and various amino acids and mixtures thereof. Examples of terpene-esters include: carvyl acetate, carvyl propionate, menthyl lactate and mixtures thereof.

Essential oils which contain terpenoids and perfumes which contain terpenoids are also useful. U.S. Pat. No. 5,227,163 disclose examples of essential oils which have a high content of terpene-ols and esters including bergamot oil (62%), sage oil (>50%), styrax oil(>50%), peppermint oil (>50%), pine siberian oil (75%) and mixtures thereof. Other examples of essential oils include, but are not limited to, aromatic oils, red thyme oil, oregano oil, aniseed oil, tea tree oil and cinnamon leaf oil and mixtures thereof. See Veal, Complementary Therapies in Nursing & Midwifery, vol. 2, pages 97-101 (1996).

1,2,3,4,-tetrahydronaphthalene (synonyms include THN, Tetranap, TETRALIN® has the molecular formula, C₁₀H₁₂ and molecular weight: 132.20. The following are characteristics of 1,2,3,4,-tetrahydronaphthalene: specific gravity (H₂0=1): 0.972 at 20/20° C.; boiling point: 207.2° C.; Melting Point: N/A; Freezing Point: −35.8° C.; Vapor Pressure: 1 mm Hg at 38° C.; Vapor Density(air=1): 4.55 pH; Unknown Solubility in Water; <0.01% weight at 60° C. Its appearance and odor are colorless to pale yellow liquid and moth-ball odor, respectively. See Merck Index, supra, page 1575.

Ivermectin (22,23-dihydroaverinectin B 1) is an antiparasitic drug that, when administered, orally paralyzes and kills treated organisms by increasing cell permeability to chloride ions which, in turn, overpolarizes nerve and muscle cells. It is a broad-spectrum member of a family of lactone antibiotics known as avermectins which are produced by cultures of the bacterium Streptomyces avermitilis. It has been used orally in animals and humans to prevent and treat a variety of parasites including Strongyloicles stercoralis and Onchocerca volvulus. A review of ivermectin in human parasitic diseases is provided in Campbell, (“Ivermectin as an Antiparasitic Agent for Use in Humans,” Annual Review of Microbiology, vol. 45, pages 445-74 (1991). Studies have shown effectiveness of ivermectin in treating human infections with Sarcoptes scabei and head lice. See U.S. Pat. No. 5,952,372.

Pyriproxyfen or (2-1-methyl-2-(4-phenoxyphenoxy) ethoxy pyridine) is a known insect growth regulator. U.S. Pat. No. 5,266,324 discloses use of pyriproxyfen in collars for domesticated animals.

Thiabendazole (2-(4′-thiazolyl)-benzimidazole) is reported to be used for the treatment and/or prevention of helminthiasis in livestock. Thiabendazole is, also, a systemic fungicide widely used for pre/post harvest spoilage. See U.S. Pat. No. 5,310,923 that provides a method for the preparation of thiabendazole.

Benzyl alcohol (benzenemethanol; phenylcarbino; phenlymeth; α-hydroxytoluene) has the molecular formula C₇H₈O and the molecular weight 108.14. Benzyl alcohol is a constituent of jasmine, hyacinth, ylang-ylang oils, Peru and Tolu balsams, and storax. Benzyl alcohol is described in The Merck Index, supra, at page 189.

Phenylethyl alcohol (2-phenylethane-2-ol; benzeneethanol; phenylethyl alcohol) has the molecular formula C₈H₁₀O and the molecular weight of 122.2.

An aromatic alcohol is an alcohol with at least one aromatic ring, including, but not limited to, benzyl alcohol and phenylethyl alcohol.

Pyrethoid insecticides include, for example, pyrethrins which refer to the active insecticidal constituents of pyrethrum flowers. Pyrethrins include 2,2-dimethyl-3-(2-methyl-1-propenyl)cyclopropanecarboxylic acid 2 methyl-4-oxo-3-(2,4-pentadienyl)-2-cyclopenten-1-yl ester and 3-(3-methoxy-2-methyl-3-oxo-1-propenyl)-2,2-dimethylcyclopropanecarboxylic acid 2-methyl-4-oxo-3-(2,4-pentadienyl)-2-cyclopenten-1-yl ester and Phenothrin, 2,2-dimenthyl-3-(2-methyl-1-propenyl)cyclopropanecarboxylic acid (3-phenoxyphenyl)methyl ester.

Other insecticides may include carbaryl, which is 1-naphthalenol methylcarbamate; DDT, which is 1,1′-(2,2,2-trichloroethylidene)bis[4-chlorobenzene]; and piperonyl butoxide, which is -[[2-(2-butoxyethoxy)ethoxy]methyl]-6-propyl-1,3-benzodioxole.

Organochlorine insecticides include lindane which is 1α,2α,3β,4α,5α,6β-hexachlorocyclohexane; permethrin is 3-(2,2-dichloroethenyl)-2,2-dimethylcyclopropanecarboxylic acid (3-phenoxyphenyl)methyl ester.

Activities of Active Ingredients

Dipentene/D/L-limonene (1-methyl-4-(1-methylethenyl)cyclohexene) is a monocyclic terpene. With acute exposures in humans, the following symptoms, among others, have been observed: increased bile flow; hypothermia; increased cytochrome P450 content; hematuria (blood in urine); albuminuria (serum globulin in urine); tachycardia (rapid heart rate); increased allergic contact eczema; and no CNS involvement.

∝-terpineol, sometimes referred to as terpineol, (1-methyl-4-isopropyl-delta-cyclohexene-8-ol), is a positional isomer of 1-terpinen-4-ol and an alcohol derivative (C₈—OH) of dipentene. Although it has a structural relationship to these two chemicals, dipentene is not metabolically converted to either α-terpineol or to 1-terpinen-4-ol in rat, guinea pig, rabbit, hamster, dog or human (Kodama et al., 1976). With acute exposures in humans, the following symptoms have been observed in the renal-kidney system: transient CNS excitation at non-fatal doses; renal failure; myoglobinuria (myohemoglobin in urine); hypotension; syncope (transient loss of consciousness due to inadequate blood flow to brain); anuria (decreased or stoppage of urine production); and bradycardia (slowing of heart rate).

1-terpinen-4-ol (1-methyl-4-isopropyl-delta-cyclohexene-4-ol) is a positional isomer of α-terpineol and an alcohol derivative (C₄—OH) of dipentene. With acute exposures in humans, the following symptoms, among others, have been observed: CNS depression; cyanosis in extremities; increased urine volume; anti-microbial activity (α-terpineol does not have this activity); and greatly decreased allergic contact eczema compared to dipentene.

1,2,3,4-tetrahydronaphthalene (TETRALIN®) from E. I. DuPont de Nemours and Company is a 10 carbon alicyclic aromatic hydrocarbon formed from naphthalene by catalytic hydrogenation. 1,2,3,4-tetrahydronaphthalene possesses very different chemistry compared to terpineol, 1-terpinen-4-ol and dipentene as described above. With acute exposures in humans, the following symptoms have been observed: transient liver damage; production of green-gray urine; CNS excitant at low concentration; depressant at high concentration; nephrotoxic (renal system damage); cataracts; liver and kidney damage; and cytotoxic to ascites cells in culture during short-term mutagenicity testing. 1,2,3,4-tetrahydronaphthalene has distinctly different chemistry and physical properties compared to terpineol, 1-terpinen-4-ol and dipentene and elicits unique acute symptomology. Additionally, it produces toxicity following subchronic exposures. 1,2,3,4-tetrahydronaphthalene produces transient liver damage but without the increased bile flow or increased cytochrome P450 content elicited by dipentene, which has the liver as a major target organ. The production of gray-green urine by 1,2,3,4-tetrahydronaphthalene is distinct from the anuria elicited by ∝-terpineol and the increased urine volume produced by 1-terpinen-4-ol. 1,2,3,4-tetrahydronaphthalene is a CNS excitant at low concentrations and a depressant at high concentrations. α-terpineol elicits only a transient CNS excitation and 1-terpinen-4-ol produces only CNS depression.

1,2,3,4-tetrahydronaphthalene appears to produce its toxicity via different mechanisms from those that result in toxicity to terpineol, 1-terpinen-4-ol or dipentene.

Dipentene shares a common terpene chemistry with α-terpineol and 1-terpinen-4-ol, which are the C₈ and C₄ positional isomers; respectively, of dipentene. They all apparently act by mechanisms of action that are distinct from each other. In humans, dipentene acts primarily on the liver whereas α-terpineol and 1-terpinen-4-ol act principally on the renal-kidney organ system. Thus, dipentene has no effect on human urine production or composition whereas α-terpineol produces anuria and 1-terpinen-4-ol results in increased urine volume. Dipentene causes tachycardia in humans whereas α-terpineol elicits bradycardia. Dipentene causes increase allergic contact eczema in humans and has been shown to be the primary cause of this symptom when humans are exposed to pine needle oil. α-terpineol has no such effect and 1-terpinen-4-ol elicits very little, if any, of the symptom. Dipentene has no CNS involvement in humans. α-terpineol produces only transient CNS excitation in humans and 1-terpinen-4-ol is a CNS depressant in humans.

Many insecticides are known to be toxic to mammals (e.g., nicotine, and pyrethrum, etc.) and share a common mechanism of action via a common or similar toxin receptor. Although the ultimate symptoms of toxicity may vary or be completely different due to different distribution of toxin receptors in mammals versus insects, the toxin-receptor interaction may be quite similar or identical between the mammals and insects.

Without being bound to theory, one theory for managing the resistance development of human ectoparasites, that is, to prevent the development of resistance in ectoparasites as well as to kill resistant ectoparasites, is to provide compositions comprising at least two active ingredients wherein each of said ingredients is selected from a different category of active ingredients or wherein each of said ingredients if believed to kill by a different licicidal killing mechanism. In preferred embodiments, each active ingredient is present in an amount effective to kill the ectoparasites. Based on the distinctly different mammalian symptoms elicited by active ingredients such as, for example, dipentene, terpineol, 1-terpinen-4-ol, and 1,2,3,4-tetrahydronaphthalene in mammals and their common bioactivity on various organisms, they will likewise elicit distinctly different symptoms in ectoparasites due to the presence of distinctly different toxin receptors for each chemical. As such, mixtures of these active ingredients appear suitable for use as a strategy for killing mammalian ectoparasites and for the resistance management of mammalian ectoparasites. The relatively low mammalian toxicity of preferred active ingredients, such as, for example, dipentene, terpineol, 1-terpinen-4-ol, 1,2,3,4-tetrahydronaphthalene and aromatic alcohol, preferably benzyl alcohol, compared to other insecticides, and their rapid metabolism and excretion by mammals should provide an ample margin of safety for use on children.

Carriers

Carriers suitable for application to mammalian skin or hair are known in the art and may be utilized here. Preferably, pharmaceutical and/or cosmetically acceptable carriers for topical application to humans or animals are utilized. Useful carriers can be organized into, but not limited to, three major types: (1) carriers that have an attraction to the active ingredients so, they are either in true solution, or pseudo solution where the particle size of the active ingredients is too small to be seen, as in certain microemulsions; (2) carriers that emulsify the active ingredients in one or more phases of the emulsion; and (3) carriers wherein the active ingredients are dispersed in various fluid, gel, emulsion, semi-solid and solid media.

Examples of carriers in group 1 that permit the active ingredients to contact the insect swiftly and in a relatively concentrated form include volatile alcohols, ketones, amides, esters, hydrocarbons, siloxanes, water and mixtures thereof. Carriers in this group that permit slower and or more dilute contact with the insect may produce slower activity. Examples are slowly volatile and non-volatile alcohols, ketones, esters, amides, hydrocarbons, siloxanes and mixtures thereof. A subset are solid and semi-solid carriers that hold active ingredients so they can also act to protect a substrate from insect attack/contact.

Active ingredients can be dissolved or solvated in carriers that emulsify the active ingredients in one or more phases of the emulsion. Active ingredients can be dissolved in the emulsion to produce faster, and/or relatively faster contact and activity. Alternately, the emulsion components dissolving or solvating the active ingredients can be chosen to produce more dilute and/or slower contact that results in slower activity. A subset is solid and semi-solid carriers that hold the active ingredients so they can also act to protect a substrate from insect attack/contact. Examples are two phase and multiple phase oil-in-water emulsion and water-in-oil emulsion that may be opaque, transparent or translucent.

A further type of carrier is one wherein the active ingredients are dispersed in various fluid, gel, emulsion, semi-solid and solid media. In this case, dispersing agents allow the active ingredients to be reduced into particles that are small enough to be dispersed within the medium. Examples of dispersants are the great many surface active agents and polymers which range from mainly hydrophilic, or mainly lipophilic, or combination of hydrophilic and lipophilic properties. The medium can be a suspension, an emulsion, or a semi-solid, such as, for example, a cream or gel.

An ectoparasite is “killed” when there is a lack of movement from the ectoparasite, as indicated by the ectoparasite generally remaining on its back and/or with a lack of peristalisis and heartbeat. Methods of measuring “killing” of ectoparasites are known in the art and are disclosed herein in the Examples. For examples of assays for measuring killing of ectoparasites, see Downs et al., British Journal of Dermatology, Vol. 141, pages 508-511 (1999), which discloses in vitro methods at page 508, right column under Subjects and Methods, and in vivo methods at page 509, left column. An ectoparasite egg is “killed” when it is prevented from hatching. The present invention encompasses ectoparasite eggs being prevented from hatching by any mechanism. In illustrative embodiments disclosed herein which provide compositions and/or methods that kill human ectoparasites, it is believed that these compositions and/or methods will also kill human ectoparasite eggs. The present invention encompasses compositions that provide, in a single treatment, at least about 50% kill effect, preferably at least about 80%, more preferably about 100%. In some cases, the treatment may be repeated at least once to approach about 100% kill effect. “Kill effect” is used herein as the percentage of ectoparasites and their eggs initially present on the mammal, which are killed. As will be understood by one of skill in the art, the present invention encompasses methods that provide single and repeated administration of the compositions provided herein.

In some embodiments, the present invention provides compositions comprising two or more ingredients, such as dipentene and terpineol, wherein said compositions kill mammalian ectoparasites more effectively than compositions comprising the individual ingredients. In other embodiments, the present invention provides compositions comprising two or more active ingredients wherein each of said active ingredients is present in a composition in an amount effective to kill mammalian ectoparasites and in additional embodiments, each of the active ingredients present in the composition kills within the same general period of time. In yet other embodiments, the present invention provides compositions and methods for killing mammalian ectoparasites which are resistant to active ingredients found in established insecticidal compositions, such as organophosphates and/or synthetic pyrethroids, or wherein said ectoparasites have a potential of developing resistance to active ingredients found in established insecticidal compositions containing at least one active ingredients. Downs et al., Parasitology Today, vol. 15, pages 1-4 (1999), reports increased tolerance to permethrin and malathion in the head lice of primary school children in the United Kingdom. Downs discloses possible insecticide resistance mechanisms including acceleration of detoxification of insecticides, e.g. by enzyme-mediated oxidation, reduction and esterification; or by alteration of the insecticide binding site, e.g. by an altered acetylcholinesterase, an altered peripheral nerve sodium channel or knockdown resistance.

The present invention is based, in part, upon the unexpected discovery that an insecticidal composition that comprises a terpene and terpene-ol, and that does not comprise malathion, rotenone, 3,8 P-menthanediol, or piperonal, kills mammalian ectoparasites and surprisingly, kills mammalian ectoparasites which are resistant to malathion. The present invention is also based, in part, upon the unexpected discovery that a composition comprising dipentene (a mixture of D/L limonene) in a concentration range from about 0.50% w/w to about 40% and terpineol in a concentration range from about 0.50% w/w to about 40% in an alcohol-containing carrier and that does not comprise malathion, rotenone, 3,8 P-menthanediol, or piperonal, killed human ectoparasites in about 30 minutes. The present invention is based, in part, upon the discovery that D-limonene and terpineol appear to be killing ectoparasites by different cellular/biochemical mechanisms.

The present invention is further based in part upon the surprising discovery that a composition comprising dipentene and terpineol in an alcohol-containing carrier kills ectoparasites resistant to malathion. As demonstrated in Example 1, a composition comprising dipentene and terpineol (Composition II as disclosed herein) kills lice in from about 30 minutes to about 60 minutes.

The use of a composition comprising D-limonene and terpineol (and that does not comprise malathion, rotenone, 3,8 P-menthanediol, or piperonal) for killing ectoparasites contributes to decreasing the potential for ectoparasite resistance development because the D-limonene and terpineol in the composition each have a similar, and optionally separate, opportunity to kill the ectoparasites. In one preferred embodiment disclosed herein, a composition comprises D-limonene and terpineol at concentrations that provide the same killing power within the same general period of time.

Without wanting to be bound by theory, the data suggest that a physical-chemical action is involved, at least initially, in producing the comparative speed of action of the D-limonene and terpineol. The D-limonene and terpineol have the ability to quickly disrupt the electrostatic, ionic and the long-chained fatty acid matrix of the ectoparasite biological membrane bonds that maintain the integrity of the insect's outer membranes and exoskeleton, thus causing loss of vital body fluids and allowing entry by the active ingredients and similar disruption and destruction within the body of the insect. This may involve interference in biological systems in vivo, thus allowing the active principals to produce secondary, toxic biological effects. The active ingredients could be dissolving the waxy coating on the insect resulting in the clogging of the insect's external respiratory organs (spiracles). This would prevent adequate amounts of oxygen from reaching the insect, resulting in death. A further advantage is that this type of physical action is potent and makes it difficult for the organism to build resistance to its action(s). Thus, few, if any, insects survive to attempt to develop resistance. Further, such resistance requires the development of a totally new and impervious shield to protect the entire body, which is a major evolutionary task.

In some preferred embodiments, the present invention provides compositions and methods for killing ectoparasites , which are resistant to at least one active ingredient, found in established insecticidal compositions, such as, for example, malathion, permethrin and/or lindane. In one embodiment, compositions for use in killing mammalian ectoparasites resistant to an established ingredient, such as, for example, pyrethrin, malathion, permethrin or lindane, comprise active ingredients that preferably have the same degree of killing power within a specified, general period of time, for example, without limitation, within about 10 to about 60 minutes, preferably within about 10 minutes to about 20 minutes, or sooner. In another embodiment, compositions for use in killing mammalian ectoparasites resistant to an established ingredient, such as, for example, malathion or permethrin or lindane, comprise active ingredients that have kill times spread out over time with each ingredient preferably in concentration ranges, wherein the entire composition provides at least about 50% kill effect, preferably at least about 80%, more preferably about 100%, in a single treatment; and in some embodiments, the treatment may be repeated at least once to approach about 100%.

In another embodiment, compositions of the present invention comprising dipentene and terpineol may further comprise additional ingredients, such as, for example, additional active ingredients, synergists, essential oils, and carriers.

In other preferred embodiments, a composition of the present invention comprises active ingredients, such as, for example, dipentene and/or terpineol and/or 1-terpinen-4-ol and/or 1,2,3,4,-tetrahydronaphthalene, and/or benzyl alcohol, and/or essential oils, in concentrations that provide about the same general ectoparasite killing power, that is about the same number of ectoparasites killed, within a specified time period, preferably about 10 to about 120 minute period of time, and most preferably, within about a 10 minute period of time to about 20 minutes, or sooner.

In other embodiments of the present invention, an insecticidal composition comprises at least two active ingredients, wherein one of the active ingredients is selected from the group consisting of terpenes and terpene-ols and the second active ingredient is not identical to said first active ingredient and is selected from the group consisting of terpenes; terpene-ols; essential oils; 1,2,3,4,-tetrahydronapthalene; aromatic alcohol, preferably benzyl alcohol; and a carrier for topical application to a mammal and wherein each of said first and said second active ingredients is present in an amount effective to kill said ectoparasites, and wherein said composition does not contain an effective amount of malathion; 3,8 P-menthanediol (Chinese crystal); rotenone; or piperonal. In some embodiments of a composition, each of the active ingredients kills about the same number of ectoparasites within the same general period of time. In other embodiments, a composition comprises active ingredients that have kill times spread out over time with each ingredient preferably in concentration ranges, wherein the entire composition provides at least about 50% kill effect, preferably at least about 80%, more preferably about 100%, in a single treatment, and in some embodiments, the treatment may be repeated at least once to approach about 100%. In other embodiments, compositions comprise additional ingredients, such as, for example, additional active ingredients, such as, for example, ivermectin, pyriproxyfen, thiabendazole and aromatic alcohol, preferably benzyl alcohol, synergists, essential oils, and carriers.

The present invention is based, in part, upon the unexpected discovery that the composition, OVIDE®, (malathion 0.5%) lotion, that comprises malathion, terpineol dipentene (a mixture of D/L limonene), isopropanol and pine needle oil, surprisingly kills mammalian ectoparasites which are resistant to malathion, and preferably malathion resistant human head lice. The present invention is also based, in part, upon the unexpected discovery that OVIDE®,(malathion 0.5%) lotion, kills ectoparasites resistant to malathion in about 30 minutes. The present invention is also based upon the discovery that the components, dipentene (D-limonene), terpineol and malathion appear to be killing ectoparasites by different cellular/biochemical mechanisms.

As demonstrated in Example 1, OVIDE®, (malathion 0.5%) lotion, a composition comprising malathion, terpineol, dipentene, isopropanol and pine needle oil is able to kill ectoparasites resistant to malathion in about 30 minutes. The speed of the killing of the ectoparasite exhibited by OVIDE®, (malathion 0.5%) lotion, contributes to decreasing the potential for resistance development because the individual active ingredients in the composition each have a similar opportunity to kill the ectoparasites within the same general period of time. In order to optimize a composition for use in killing mammalian ectoparasites resistant to an established ingredient, such as, for example, malathion or permethrin or lindane, the active ingredients in the composition, in one embodiment, may have the same degree of killing power within a specified, general period of time, for example, each ingredient killing within about 10 to about 60 minutes, most preferably within about 10 minutes.

In some embodiments, insecticidal compositions used in the methods of the present invention comprise malathion, in a range of from about 0.02% to about 5% w/w (preferably about 0.10% to about 2%); and dipentene and terpineol, each in a range of from about 1% w/w to about 20% w/w. In other embodiments, insecticidal compositions used in the methods of the present invention comprise malathion in a range of from about 0.02% to about 5%, preferably about 0.25% w/w to about 0.75% w/w; and dipentene and terpineol, each in a range of from about 5% w/w to about 12% w/w.

In some embodiments, each of the active ingredients i.e., malathion, dipentene and/or D-limonene, and terpineol, is present in a concentration such that each kills within the same general period of time. In other embodiments, each active ingredient is present in a concentration, wherein the entire composition provides at least about 50% kill effect, preferably at least about 80%, more preferably about 100%, in a single treatment; and in some embodiments, the treatment may be repeated at least once to approach about 100%. The killing times for each active ingredients may be spread out over time rather than being compressed within the same general period of time. In other embodiments, compositions comprising malathion, dipentene and terpineol, comprise additional ingredients, such as, for example, additional active ingredients, synergists, essential oils, and carriers.

An “active ingredient” is one that kills an ectoparasite by any mechanism. In some embodiments, an active ingredient is able to kill in about 30 minutes. Examples of active ingredients encompassed within the present invention include for example, malathion, terpenes, such as dipentene and D-limonene; and terpene-ols, such as terpineol and terpinen-4-ol; essential oils; 1,2,3,4, tetrahydronaphthalene; ivermectin; pyriproxyfen; thiabendazole; aromatic alcohol, preferably benzyl alcohol; and combinations thereof. As disclosed herein, different categories of active ingredients will elicit different symptoms in ectoparasites and/or ectoparasite eggs due to the presence of distinctly different toxin receptors and/or biochemical pathways for each chemical. For example, as disclosed herein, 1,2,3,4-tetrahydronaphthalene appears to produce its toxicity via different mechanisms and/or biochemical pathways from those that result in toxicity to terpineol, 1-terpinen-4-ol, dipentene, and D-limonene. Terpineol appears to produce its toxicity via different mechanisms and/or biochemical pathways from those that result in toxicity to 1-terpinen-4-ol and D-limonene; and 1-terpinen-4-ol appears to produce its toxicity via different mechanism and/or biochemical pathways than dipentene or D-limonene. Regarding the effect of active ingredients on ectoparasite eggs, without wanting to be bound to theory, it is thought that the active ingredients disrupt the egg surface, such as by, for example, breaking down the membrane, and/or penetrate the eggs, causing fetal toxicity in manner that is similar to the mature ectoparasite.

The present invention encompasses compositions that comprise at least one active ingredient, such as malathion, dipentene and terpineol, and at least one additional ingredient that is synergistic with at least one active ingredient (“synergist”). The present invention encompasses compositions comprising synergistic combinations of ingredients. Active ingredients are considered to be synergistic when their combined killing effect is greater than additive of the individual killing effects. The present invention also encompasses compositions that comprise at least one active ingredient and at least one ingredient that acts as an adjuvant. An adjuvant is an ingredient that assists in the killing event in some way. Examples of adjuvants include, for example, certain essential oils, such as, for example peppermint oil and sesame oil, that do not substantially kill ectoparasites on their own but which in combination with an active ingredient, assists the killing effect of the active ingredient, such as, for example, by maintaining the active ingredient in place on the area to be treated.

In one preferred embodiment, a composition comprises at least two active ingredients, such as, D-limonene and/or dipentene and terpineol, wherein the individual active ingredients in the composition are present at concentrations that provide the same or similar killing power (e.g., LD₅₀, that is the dose which kills 50% of the ectoparasite) for ectoparasites within the same general period of time, such as, for example, about 15 minutes. The activity of such a composition can be increased by increasing the amount of each individual ingredient to higher concentrations to produce higher kill effect, since ectoparasites known to be resistant to active ingredients may require higher concentrations of an active ingredient for killing. Thus, a higher concentration of an active ingredient may be used to kill any ectoparasites that might develop partial or full resistance to any active ingredient in the composition. LD₅₀ values for individual ingredients are determined from concentration versus ectoparasite killing rate curves within a specified time. For example, for a terpene or a terpene-ol, concentrations of the terpene or terpene-ol of from about 0.10% up to about 50% are assayed for the ability of each concentration to kill 50% of the ectoparasites in a given time period.

In another preferred embodiment, the concentration of each of the individual active ingredients provides at least about 80%, preferably about 100% killing and the killing times for the active ingredients are spread out over time rather than being compressed within the same general period of time. In order to ensure against the appearance of ectoparasite offspring that might develop partial or full resistance to an active ingredient in a composition, higher concentrations of each active ingredient may be used.

In some embodiments, compositions used in the methods of the present invention comprise malathion in a range of from about 0.02% to about 5%, preferably about 0.10% to about 2% w/w. more preferably from about 0.25% to about 0.75% w/w. In further embodiments, the range of malathion is from about 0.02%, 0.05%, 0.10%, 0.15%, 0.20%. 0.25%, 0.30%, 0.35%, 0.40%, 0.45%, 0.50%, 0.55%, 0.60%, 0.65%, 0.70%, 0.75%, 0.80%, 0.85%, 0.90%, 0.95%, 1.00%, 1.10%, 1.20%, 1.30%, 1.40%, 1.50%, 1.60%. 1.70%, 1.80%, 1.90%, 2.00%, 2.10%, 2.20%, 2.30%, 2.40%, 2.50%, 2.60%, 2.70%, 2.80%, 2.90%, 3.00%, 3.10%, 3.20%. 3.30%. 3.40%, 3.50%, 3.60%, 3.70%, 3.80%, 3.90%, 4.00%, 4.10%, 4.20%, 4.30%, 4.40%, 4.50%, 4.60%, 4.70%, 4.80%, 4.90%, up to and including about 5.0%.

In some embodiments, compositions of the present invention comprise dipentene and terpineol. Terpineol is less oil soluble than dipentene, therefore, the combination of dipentene and/or D-limonene and terpineol provides a bipolar mixture, that is, one part of the composition is more water soluble and another part is more oil soluble. In some embodiments, the lower range of dipentene or terpineol or terpinen-4-ol in a composition comprising dipentene or terpineol or terpinen-4-ol is at least about 0.10%, 0.15%, 0.20%, 0.25%, 0.30%, 0.35%, 0.40%, 0.45%, 0.50%, 0.55%, 0.60%, 0.65%, 0.70%, 0.75%, 0.80%, 0.85%, 0.90%, 0.95%, 1.00%, 1.05%, 1.10%, 1.15%, 1.20%, 1.25%, 1.30%, 1.35%, 1.40%, 1.45%, 1.50%, 1.55%, 1.60%, 1.65%, 1.70%, 1.75%, 1.80%, 1.85%, 1.90%, 1.95%, 2.00%, 2.05%, 2.10%, 2.15%, 2.20%, 2.25%, 2.30%, 2.35%, 2.40%, 2.45%, 2.50%, 2.55%, 2.60%, 2.65%, 2.70%, 2.75%, 2.80%, 2.85%, 2.90%, 2.95%, 3.00%, 3.05%, 3.10%, 3.15%, 3.20%, 3.25%, 3.30%, 3.35%, 3.40%, 3.45%, 3.50%, 3.55%, 3.60%, 3.65%, 3.70%, 3.75%, 3.80%, 3.85%, 3.90%, 3.95%, 4.00%, 4.05%, 4.10%, 4.15%, 4.20%, 4.25%, 4.30%, 4.35%, 4.40%, 4.45%, 4.50%, 4.55%, 4.60%, 4.65%, 4.70%, 4.75%, 4.80%, 4.85%, 4.90%, 4.95%, or 5.00% w/w. In other embodiments, the upper range of dipentene or terpineol or terpinen-4-ol in a composition comprising dipentene and/or D-limonene or terpineol or terpinen-4-ol is at the level of the maximum amount safely used with a specific carrier or at least about 10%, 12.5%, 15%, 17.5%, 20%, 22.5%, 25%, 27.5%, 30%, 32.5%, 35%, 37.5%, 40%, 42.5%, 45%, 47.5%, or 50% w/w.

In other preferred embodiments, both dipentene and terpineol are present in a composition in the range of from about 0.50% w/w to about 40% w/w. In another preferred embodiment, both dipentene and terpineol are present in a composition in the range of from about 2.50% w/w to about 20% w/w. In a further preferred embodiment, both dipentene and/or D-limonene and terpineol are present in a composition in the range of from about 5% w/w to about 15% w/w.

In other preferred embodiments, 1,2,3,4,-tetrahydronaphthalene is present in a composition in the range of from about 0.50% w/w to about 40% w/w. In another preferred embodiment, 1,2,3,4,-tetrahydronaphthalene is present in a composition in the range of from about 2.5% w/w to about 20% w/w. In yet other embodiments, 1,2,3,4,-tetrahydronaphthalene is present in a composition in the range of from about 5% w/w to about 15% w/w. In yet other embodiments, the 1,2,3,4,-tetrahydronaphthalene is present in a composition in the range of from about 5% w/w to about 10% W/W.

In other preferred embodiments, an essential oil (including, but not limited to aromatic oil) that is an active ingredient is present in a composition in the range of from about 0.10% w/w to about 10% w/w. In other preferred embodiments, an essential oil that is an active ingredient is present in a composition in the range of from about 1% w/w to about 5% w/w.

In yet other preferred embodiments of the present invention, an aromatic alcohol, which may include, but is not limited to, benzyl alcohol and/or phenylethyl alcohol, is used as an active ingredient, and is effective at killing ectoparasites. Benzyl alcohol, for example, is effective at killing ectoparasites within about 20 minutes, or preferably less time, of the initial application. An aromatic alcohol may be used as an active ingredient alone or in combination with other active ingredients.

In a preferred embodiment, benzyl alcohol is present in a composition in the range of from about 0.50% w/w to about 20% w/w. In additional preferred embodiments, benzyl alcohol is present in a composition in the range of from about 3% w/w to about 6% w/w, preferably 4.5% w/w.

In other embodiments, compositions comprise malathion, dipentene and/or D-limonene, terpineol and 1,2,3,4,-tetrahydronaphthalene and combinations thereof. In yet other embodiments, compositions comprise malathion, dipentene and/or D-limonene, terpineol, 1,2,3,4,-tetrahydronaphthalene and an essential oil and combinations thereof. In yet other embodiments, compositions comprise malathion, dipentene, terpineol, 1,2,3,4,-tetrahydronaphthalene, an essential oil and terpinen-4-ol and combinations thereof. In yet other embodiments, compositions comprise malathion; dipentene; terpineol; aromatic alcohol, preferably benzyl alcohol; isopropanol and combinations thereof.

The active ingredients in the composition can be combined with a carrier as described supra such as, for example, a pharmaceutically and/or cosmetically acceptable carrier for topical administration to the (a) hair and scalp to treat ectoparasites, preferably head lice or mites, (b) skin to treat ectoparasites, preferably scabies, body lice or mites, (c) pubic area to treat ectoparasites, such as pubic lice or mites, and, (d) animal skin and/or hair to treat ectoparasites, preferably animal lice, fleas, ticks. Examples of carriers may include alcohol solution such as isopropanol, ethanol or combination of both; an alcohol/water solution mixture; water; polyethylene glycol; polyethylene glycol and water; polyethylene glycol and alcohol; other aqueous and non-aqueous formulations; a hydrophobic material; a gel; a cream; a powder; a cleanser (preferably, a shampoo); a lotion; a hair styling mousse; a hair or fur conditioner; a spray; an emulsion; a dispersion; a micro-emulsion; a foam; a créme rinse and combinations thereof. In the present invention, a preferred carrier is an alcohol, such as, for example, isopropanol. Carriers suitable for use may also comprise antimicrobial preservatives, antioxidants and/or fragrances. The present invention provides compositions and methods for killing mammalian ectoparasites which are resistant to active ingredients found in established insecticidal compositions, such as organophosphates and/or synthetic pyrethroids and/or organochorides and/or lindane, or wherein said ectoparasites and/or ectoparasite eggs have a potential of developing resistance to active ingredients found in established insecticidal compositions. In some embodiments, the core ingredients used in compositions for the treatment of lice which are resistant to established compositions include, but are not limited to the following combinations: malathion, terpineol, and dipentene; malathion, terpineol, dipentene, and 1,2,3,4,-tetrahydronaphthalene; malathion, terpineol, dipentene, and terpinen-4-ol; malathion, terpineol, dipentene, 1,2,3,4,-tetrahydronaphthalene, and terpinen-4-ol; malathion, terpineol, dipentene and/or D-limonene, and benzyl alcohol; terpineol and dipentene; terpineol, dipentene and 1,2,3,4,-tetrahydronaphthalene; terpineol, dipentene and terpinen-4-ol; terpineol, dipentene and/or D-limonene, 1,2,3,4,-tetrahydronapfithalene, and terpinen-4-ol; and terpineol, dipentene, and aromatic alcohol, preferably benzyl alcohol. In some embodiments, these combinations are used together with essential oils and/or alcohol carriers such as, for example, isopropanol. Additional active ingredients, such as ivermectin, thiabendazole, pyriproxyfen, and aromatic alcohol, preferably benzyl alcohol, can be added to these combinations.

Compositions of the present invention can be prepared by means known to those of skill in the art. In a preferred embodiment wherein the carrier is isopropanol, each active ingredient is dissolved in isopropanol and if needed, isopropanol is added to bring the composition up to the final volume or weight. The ingredients can be added to the isopropanol in any order. In an illustrative embodiment, Composition II tested in Example I is a solution that is prepared by dissolving the following ingredients in the following order in isopropanol: terpineol, dipentene, and pine needle oil. As is known by those of skill in the art, the process can take place in the presence of nitrogen, carbon dioxide or other gasses to inhibit oxidation and/or other undesirable processes. Those skilled in the art will also know that the active ingredients, such as, for example, malathion, dipentene, and/or terpineol can also be incorporated into other vehicles well known in the art, such as, for example, regular emulsions (often opaque), microemulsions (often translucent or clear), dispersions (often having a milky appearance due to the dispersed-suspended agents), absorbates or adsorbates and complexes which can be applied as powders. Additionally, the active ingredients can be made into tablets, boluses, capsules, lotions, gels, cleansers (preferably shampoos), creams, various constant- or sustained-dosage devices, or applied as mists or sprays, or absorbed or adsorbed or coated onto substances to act as contact treatments in a manner, known to those of ordinary skill in the art, to facilitate usage.

A preferred embodiment is a composition comprising pyrethrin, piperonyl butoxide, dipentene, α-terpineol, benzyl alcohol, ethyl alcohol, glycerin or propylene glycol, zinc omadine, a gel agent, laureth-4, dimethyl isosorbide, and water. The pyrethrin is present at an effective amount, preferably about 0.17% to about 0.33%, piperonyl butoxide is present preferably at about 2% to about 4%, dipentene is present preferably at about 2.5%, α-terpineol is present preferably at about 2.5%, benzyl alcohol is present preferably at about 4%, ethyl alcohol is present preferably at about 15%, glycerin or propylene glycol is present preferably at about 2%, zinc omadine is present preferably at about 0.10 to about 0.25%, a gel agent (such as, without limitation hydroxyethyl cellulose or hydroxypropyl cellulose) is present preferably at about 1%, laureth-4 is present preferably at about 1%, dimethylisosorbide is present preferably at about 0.5%, and the remainder of the composition is preferably water (these percentages are by weight). Benzyl alcohol, phenylethyl alcohol or other aromatic alcohols, traditionally used as preservatives, may be used in the present embodiment as an active ingredient. The composition is preferably a gel for application to the hair and scalp. Optionally, cleansing and foaming agents or combinations thereof can be added to provide a cleansing function.

A preferred embodiment of the present invention comprises applying a composition to mammalian ectoparasites on mammals for a short time (for example, without limitation, about 5 to about 30 minutes), and then rinsing. The ectoparasites are killed or stunned and the live and dead ectoparasites and their eggs are effectively removed from the mammal.

Examples of preferred compositions of the present invention include, but are not limited to the following compositions.

Composition I

| Ingredient | % W/W/ |
|---|---|
| Isopropyl alcohol | 76.56 |
| Terpineol | 12.67 |
| Dipentene | 10.49 |
| Pine Needle Oil | 0.28 |
| Total | 100.00 |

Composition II

| Ingredient | % W/W/ |
|---|---|
| Isopropyl alcohol | 78.75 |
| Terpineol | 11.00 |
| Dipentene | 10.00 |
| Pine Needle Oil | 00.25 |
| Total | 100.00 |

Composition III

| Ingredient | % W/W/ |
|---|---|
| Isopropyl alcohol | 66.56 |
| Terpineol | 12.67 |
| Dipentene | 10.49 |
| 1,2,3,4,-tetrahydronaphthalene | 10.00 |
| Pine Needle Oil | 0.28 |
| Total | 100.00 |

Composition IV

| Ingredient | % W/W/ |
|---|---|
| Isopropyl alcohol | 66.56 |
| Terpineol | 12.67 |
| Dipentene | 10.49 |
| Terpinen-4-ol | 10.00 |
| Pine Needle Oil | 0.28 |
| Total | 100.00 |

Composition V

| Ingredient | % W/W/ |
|---|---|
| Isopropyl alcohol | 76.56 |
| Terpineol | 12.67 |
| D/L-limonene | 10.49 |
| Pine Needle Oil | 0.28 |
| Total | 100.00 |

Composition VI

| Ingredient | % W/W/ |
|---|---|
| Isopropyl alcohol | 71.56 |
| D-limonene | 10.49 |
| Pine Needle Oil | 0.28 |
| Benzyl alcohol | 5.00 |
| Total | 100.00 |

Composition VII

| Ingredient | % W/W/ |
|---|---|
| Isopropyl alcohol | 61.56 |
| Terpineol | 12.67 |
| D-limonene | 10.49 |
| Terpinen-4-ol | 10.00 |
| Pine Needle Oil | 0.28 |
| Benzyl alcohol | 5.00 |
| Total | 100.00 |

Composition VIII

| Ingredient | % W/W/ |
|---|---|
| Isopropyl alcohol | 79.75 |
| Terpineol | 5.00 |
| D-limonene | 5.00 |
| Terpinen-4-ol | 5.00 |
| Benzyl alcohol | 5.00 |
| Pine Needle Oil | 0.25 |
| Total | 100.00 |

Composition IX

| Ingredient | % W/W/ |
|---|---|
| Isopropyl alcohol | 78.25 |
| Terpineol | 8.00 |
| Terpinen-4-ol | 8.00 |
| Benzyl alcohol | 5.50 |
| Pine Needle Oil | 0.25 |
| Total | 100.00 |

Composition X

| Ingredient | % W/W/ |
|---|---|
| Isopropyl alcohol | 65.00 |
| Terpineol | 10.00 |
| D-limonene | 10.00 |
| Benzyl alcohol | 5.00 |
| terpinen-4-ol | 10.00 |
| Total | 100.00 |

Composition XI

| Ingredient | % W/W/ |
|---|---|
| Isopropyl alcohol | 65.00 |
| Terpineol | 10.00 |
| D-limonene | 10.00 |
| Benzyl alcohol | 5.00 |
| 1,2,3,4,-tetrahydronaphthalene | 10.00 |
| Total | 100.00 |

Composition XII

| Ingredient | % W/W/ |
|---|---|
| Pyrethrin | 0.17-0.33 |
| Piperonyl butoxide | 2.0-4.0 |
| Dipentene | 2.5 |
| ∝-terpineol | 2.5 |
| Benzyl alcohol | 4.0 |
| Ethyl alcohol | 15.0 |
| Glycerin | 2.0 |
| Zinc omadine | 0.10-0.25 |
| Gel agent | Effective amount |
| Laureth-4 | 1.0 |
| Dimethyl isosorbide | 0.5 |
| Water | QS |
| Total | 100.00 |

*QS is quantity sufficient to total 100% w/w.

Composition XIII

| Ingredient | % W/W/ |
|---|---|
| Pyrethrin | 0.17-0.33 |
| Piperonyl butoxide | 2.0-4.0 |
| Dipentene | 2.5 |
| ∝-terpineol | 2.5 |
| Benzyl alcohol | 4.0 |
| Ethyl alcohol | 15.0 |
| Propylene glycol | 2.0 |
| Zinc omadine | 0.10-0.25 |
| Gelling agent | Effective amount |
| Laureth-4 | 1.0 |
| Dimethyl isosorbide | 0.5 |
| Water | QS |
| Total | 100.00 |

The following examples are provided to illustrate, but not limit, the invention. All references and patent publications disclosed herein are hereby incorporated in their entirety by reference.

### EXAMPLES

### Example 1

Research has shown the occurrence of pyrethroid and malathion resistant head lice in children in south Bristol and Bath (see Downs, et al. British Journal of Dermatology, Vol. 141, pages 508-511(1999), and across England.

The present example tests OVIDE® (malathion 0.5%) lotion, (available from Medicis Pharmaceutical Corp., Scottsdale, Ariz. and which contains 0.5% malathion w/v and terpineol, 11.0% v/v, dipentene, 10.0% v/v, pine needle oil, 0.25% v/v and isopropanol at 78.0% v/v), and Composition II disclosed herein for their effect on resistant lice.

Materials and Methods

Following approval by the South and West Hospital research ethics committee, three primary schools in south Bristol, U.K. were contacted and arrangements were made with the headmaster/mistress and the school nurse to visit the schools and comb the hair of every child who has parental permission. Head lice were collected from children between 4 years and 11 years of age using plastic louse detector combs.

Head lice were placed and maintained at about 30° C. and about 70% relative humidity in a portable incubator for up to about two hours before being placed on filter paper test disks in small disposable petri dishes. These conditions of maintenance were the optimum for the lice off the human head. These head lice were then randomly distributed to petri dishes containing the control or impregnated disks and their activity was monitored by inspection over a four hour period. Since the portable incubator was designed to function either from the mains or a 12 volt source (cigarette lighter outlet in a car) the checking of lice activity was undertaken after leaving the school.

The disks, 5 cm in diameter, are paper, Whatman No. 1 Control paper disks were prepared by dipping papers into isopropanol and allowed to dry. Paper disks were prepared by dipping the paper into the solution of insecticide and allowed it to dry. Solutions used with the paper disks were 0.5% malathion in isopropanol, OVIDE® (malathion 0.5%) lotion, or Composition II disclosed herein. The dried paper disks were then stored overnight in air tight containers before using them the next day.

895 children were inspected over three days being about 92% of the school population. About 18% of the children were infested.

In the two subsequent tests, filter paper test disks were also used. The combined results were given in Table 1. No deaths occurred in the controls. Malathion alone killed approximately 50% of the lice after about 4 hours. OVIDE® (malathion) lotion, 0.5%, and Composition II killed 100% of the lice within about 30-60 minutes.

Table 1 shows the activity of malathion, OVIDE® (malathion 0.5%) lotion, and Composition II against head lice collected from Bristol school children. Values are given as percentage activity of the lice, 100 being all alive, 0 being all dead.

TABLE 1

| | | | Ovide ® | |
|---|---|---|---|---|
| | | | (malathion | |
| | Malathion | Composition II | 0.5%) lotion | Control |
| | Numbers of lie tested | | | |
| Time (mins) | 50 | 80 | 80 | 40 |
| 0 | 100 | 100 | 100 | 100 |
| 1 | 100 | 94 | 94 | 100 |
| 5 | 100 | 88 | 94 | 100 |
| 10 | 100 | 88 | 94 | 100 |
| 20 | 100 | 13 | 25 | 100 |
| 30 | 100 | 3 | 1 | 100 |
| 60 | 100 | 0 | 0 | 100 |
| 90 | 90 | 0 | 0 | 100 |
| 120 | 80 | 0 | 0 | 100 |
| 180 | 60 | 0 | 0 | 100 |
| 240 | 50 | 0 | 0 | 100 |

### Example 2

This example illustrates that a composition containing dipentene at about 8.5% w/w; α-terpineol, at about 10.27% w/w; Pine needle oil at about 0.23% w/w in Isopropanol up to 100% kills head lice in a manner that is superior to about 0.55% w/w of malathion alone. The viability of head lice was tested on filter paper under conditions as described in Example 1.

Table 2 shows the percentage of lice still alive after about 1, 5, 10, 20, 30 and 60 minutes. 100% lice were killed with the dipentene, terpineol, pine oil and isopropanol mixture between about 30 and about 60 minutes.

TABLE 2
Percent of Lice Still Alive

| | 0.55% w/w | Dipentene + Terpineol + |
|---|---|---|
| After Minutes | Malathion alone | pine oil + isopropanol* |
| None | 100 | 100 |
| 1 minute | 100 | 94 |
| 5 minutes | 100 | 88 |
| 10 minutes | 100 | 88 |
| 20 minutes | 100 | 13 |
| 30 minutes | 100 | 3 |
| 60 minutes | 100 | 0 (100% killed) |

*The isopropanol evaporated and was not present when the lice were exposed to the filter paper.

### Example 3

This example compares the in vitro activity of the OVIDE® (malathion 0.5%) lotion, to Composition II and a water control.

Materials and Methods

For the present study, following approval by the South and West Hospital research ethics committee, a primary school in south Bristol was contacted and arrangements were made with the headmaster and the school nurse to visit the school and comb the hair of every child who has parental permission. Head lice were collected from children between 4 years and 11 years of age using plastic louse detector combs.

Head lice were maintained at about 30° C. and about 70% relative humidity in a portable incubator for up to two hours before being placed on paper disks in small disposable petri dishes. The conditions of maintenance were the optimum for the lice off the human head. Head lice were randomly distributed to petri dishes containing the control or impregnated disks and their activity was monitored by inspection over a six hour period. Since the portable incubator was designed to function either from the mains or a 12 volt source (cigarette lighter outlet in a car) the checking of lice activity was undertaken after leaving the school.

Whatman No. 15 cm diameter filter paper test disks were used. Control disks were dipped in water and allowed to dry overnight. For tests with the liquid formulation of OVIDE® (malathion 0.5%) lotion, paper disks were prepared by dipping the paper into solutions of and allowing it to dry. Solutions used with the paper disks were OVIDE® (malathion 0.5%) lotion, or Composition II. The dried paper disks were then stored overnight in air tight containers before being used the next day. Two unimpregnated filter papers acted as controls. The head lice were placed on the filter paper test disks and mortality was assessed at regular time intervals up to 6 hours.

Results

Lice were collected from 315 children and used as described in the methods described above. The results of the tests are provided in Table 3. Control lice started dying after about 4 hours. In contrast, all lice were dead within about 60 minutes on OVIDE® (malathion 0.5%) lotion, and Composition II impregnated papers.

Discussion

The results with the OVIDE® (malathion 0.5%) lotion, and Composition II impregnated papers confirm our earlier observations that all lice die within about 60 minutes of contact. The activity of the Composition II suggests that with more than one active ingredient in a composition, the chances of developing resistance to malathion should be lower than with malathion on its own.

The activity of OVIDE® (malathion 0.5%) lotion, and Composition II against head lice collected from Bristol school children. Values are given as percentage activity of the lice, 100 being all alive, 0 being all dead. Each test consists of three replicates of 20 lice per petri dish. The controls are two dishes of 20 lice per dish.

TABLE 3

| | | | Ovide ® |
|---|---|---|---|
| | | | (malathion |
| Time (mins) | Control | Composition II | 0.5%) lotion |
| 0 | 100 | 100 | 100 |
| 5 | 100 | 100 | 100 |
| 10 | 100 | 67 | 67 |
| 20 | 100 | 25 | 17 |
| 30 | 100 | 8 | 0 |
| 60 | 100 | 0 | 0 |
| 90 | 100 | 0 | 0 |
| 120 | 100 | 0 | 0 |
| 180 | 100 | 0 | 0 |
| 240 | 95 | 0 | 0 |
| 300 | 95 | 0 | 0 |
| 360 | 85 | 0 | 0 |

It is understood that while the invention has been described in conjunction with the detailed description thereof, that the foregoing description is intended to illustrate and not limit the scope of the invention, which is defined by the scope of the appended claims. Other aspects, advantages, and modifications are evident from a review of the following claims.

We claim:

1. A composition for killing mammalian ectoparasites and/or their eggs comprising
pyrethrum;
benzyl alcohol;
α-terpineol;
d-limonene, wherein pyrethrum, benzyl alcohol, α-terpineol, and D-limonene are each present in an amount effective to kill ectoparasites; and
a carrier for topical application, wherein the composition is substantially free from malathion, 3,8-P-methanediol, rotenone and piperonal.

2. The composition of claim 1 further comprising a synergist of pyrethrum.

3. The composition of claim 2 wherein the synergist comprises piperonyl butoxide.

4. The composition of claim 3 wherein pyrethrum is present from about 0.17% to about 0.33%, piperonyl butoxide is present from about 2% to about 4%, benzyl alcohol is present from about 2% to about 20%, α-terpineol is present from about 1% to about 10%, and D-limonene is present from about 1% to about 10%.

5. The composition of claim 3 wherein pyrethrum is present at about 0.17%, piperonyl butoxide is present at about 2%, benzyl alcohol is present at about 4.5%, α-terpineol is present at about 2.5%, and D-limonene is present at about 2.5%.

6. The composition of claim 1 wherein the carrier is selected from the group consisting of an alcohol solution, an alcohol dispersed system, an aqueous solution, an aqueous dispersed system and combinations thereof.

7. The composition of claim 1 wherein the carrier comprises isopropanol.

8. The composition of claim 1 wherein the ectoparasites are selected from the group consisting of human head lice, human body lice, human pubic lice, human mites, scabies and fleas.

9. The composition of claim 1 wherein the ectoparasites comprise human head lice.

10. The composition of claim 1 wherein the composition is selected from the group consisting of a cleanser and a gel.

11. A composition for killing mammalian ectoparasites and/or their eggs comprising
an aromatic alcohol; and
a carrier for topical application, wherein the composition is substantially free from other active ingredients.

12. The composition of claim 11 wherein the aromatic alcohol comprises benzyl alcohol.

13. The composition of claim 11 wherein the aromatic alcohol comprises phenylethyl alcohol.

14. The composition of claim 11 wherein the carrier is selected from the group consisting of an alcohol solution, an alcohol dispersed system, an aqueous solution, an aqueous dispersed system and combinations thereof.

15. The composition of claim 11 wherein the carrier comprises ethyl alcohol.

16. The composition of claim 11 wherein the composition is selected from the group consisting of a cleanser and a gel.

17. A method for killing mammalian ectoparasites and/or their eggs on a mammal, comprising applying to the mammal a composition comprising pyrethrum; benzyl alcohol; α-terpineol; D-limonene, wherein pyrethrum, benzyl alcohol, α-terpineol, and D-limonene are each present in an amount effective to kill ectoparasites; and a carrier for topical application, wherein the composition is substantially free from malathion, 3,8-P-methanediol, rotenone, and piperonal.

18. The method of claim 17 wherein the composition further comprises a synergist of pyrethrum.

19. The method of claim 18 wherein the synergist comprises piperonyl butoxide.

20. The method of claim 19 wherein pyrethrum is present from about 0.17% to about 0.33%, piperonyl butoxide is present from about 2% to about 4%, benzyl alcohol is present from about 2% to about 20%, α-terpineol is present from about 1% to about 10%, and D-limonene is present from about 1% to about 10%.

21. The method of claim 19 wherein pyrethrum is present at about 0.17%, piperonyl butoxide is present at about 2%, benzyl alcohol is present at about 4.5%, α-terpineol is present at about 2.5%, and D-limonene is present at about 2.5%.

22. The method of claim 17 wherein the carrier is selected from the group consisting of an alcohol solution, an alcohol dispersed system, an aqueous solution, an aqueous dispersed system and combinations thereof.

23. The method of claim 17 wherein the carrier comprises isopropanol.

24. The method of claim 17 wherein the ectoparasites are selected from the group consisting of human head lice, human body lice, human pubic lice, human mites, scabies and fleas.

25. The method of claim 17 wherein the ectoparasites comprise human head lice.

26. The method of claim 17 wherein the composition is selected from the group consisting of a cleanser and a gel.

27. A composition for killing mammalian ectoparasites and/or their eggs comprising
an aromatic alcohol;
one or more additional active ingredients; and
a carrier for topical application to a mammal.

28. The composition of claim 27 wherein the aromatic alcohol comprises benzyl alcohol.

29. The composition of claim 27 wherein the aromatic alcohol comprises phenylethyl alcohol.

30. The composition of claim 27 wherein the active ingredients comprise pyrethrin.

31. The composition of claim 27 wherein the active ingredients comprise dipentene.

32. The composition of claim 27 wherein the active ingredients comprise pyrethrin and dipentene.

33. The composition of claim 27 wherein the active ingredients comprise α-terpineol.

34. The composition of claim 27 wherein the active ingredients comprise α-terpineol and dipentene.

35. The composition of claim 27 wherein the active ingredients comprise pyrethrin, dipentene, and α-terpineol.

36. The composition of claim 27 further comprising a synergist.

37. The composition of claim 35 wherein the synergist comprises piperonyl butoxide.

38. The composition of claim 27 further comprising a detergent.

39. The composition of claim 38 wherein the detergent comprises laureth-4.

40. The composition of claim 27 further comprising a gel agent.

41. The composition of claim 40 wherein the gel agent comprises hydroxyethyl cellulose.

42. The composition of claim 40 wherein the gel agent comprises hydroxypropyl cellulose.

43. A method for removing mammalian ectoparasites and/or their eggs comprising
applying the composition of claim 27 topically to a mammal, and
cleansing the composition from the mammal, wherein the cleansing substantially removes the live and dead ectoparasites.

44. A method for killing mammalian ectoparasites and/or their eggs on a mammal infected with ectoparasites that are resistant to an active ingredient comprising, applying to a mammal infected with the ectoparasites a composition comprising i) dipentene; ii) terpineol; iii) an essential oil and iv) isopropanol, wherein said composition is substantially free from malathion, 3,8-P-methanediol, rotenone, and piperonal.

45. The method of claim 44 wherein said composition comprises dipentene from about 0.10% w/w to about 50.00% w/w and terpineol from about 0.10% w/w to about 50.00% w/w.

46. The method of claim 44 wherein said composition comprises dipentene from about 2.50% w/w to about 20.00% w/w and terpineol from about 2.50% w/w to about 20.00% w/w.

47. The method of claim 44 wherein said composition comprises dipentene from about 5.00% w/w to about 15.00% w/w and terpineol from about 5.00% w/w to about 15.00% w/w.

48. The method of claim 44 wherein the composition further comprises an active ingredient selected from the group consisting of terpinen-4-ol; 1,2,3,4-tetrahydronaphthalene; thiabendazole; ivermectin; pyriproxyfen; and aromatic alcohol.

49. A method for killing mammalian ectoparasites and/or their eggs on a mammal infected with ectoparasites that are resistant to an active ingredient comprising, applying to a mammal infected with the ectoparasites a composition comprising
an aromatic alcohol; and
a carrier for topical application, wherein the composition is substantially free from other active ingredients.

50. The method of claim 49 wherein the aromatic alcohol comprises benzyl alcohol.

51. A composition for killing mammalian ectoparasites and/or their eggs comprising
pyrethrin,
piperonyl butoxide,
dipentene,
α-terpineol,
benzyl alcohol,
ethyl alcohol,
glycerin,
zinc omadine,
a gel agent,
laureth-4, and
dimethyl isosorbide.

52. A composition for killing mammalian ectoparasites and/or their eggs comprising
pyrethrin,
piperonyl butoxide,
dipentene,
α-terpineol,
benzyl alcohol,
ethyl alcohol,
propylene glycol,
zinc omadine,
a gel agent,
laureth-4, and
dimethyl isosorbide.
